(19) United States
(12) Patent Application Publication
(10) Pub. No.: US 2025/0042021 A1
(43) Pub. Date: Feb. 6, 2025

(54) METHOD AND DEVICE OF CONTROLLING PNEUMATIC MUSCLE DEVICE THROUGH ELECTROMYOGRAPHIC SIGNAL, AND TERMINAL APPARATUS

(71) Applicant: THE HONG KONG POLYTECHNIC UNIVERSITY, Hung Hom Kowloon (HK)

(72) Inventors: Rui SUN, Hung Hom Kowloon (HK); Yu Lok WONG, Hung Hom Kowloon (HK); Ching Hang FONG, Hung Hom Kowloon (HK)

(21) Appl. No.: 18/790,575

(22) Filed: Jul. 31, 2024

(30) Foreign Application Priority Data
Jul. 31, 2023 (CN) 202310952647.3

(51) Int. Cl. B25J 9/16; A61H 1/02; B25J 9/00; B25J 9/14

(52) U.S. Cl. CPC B25J 9/161; A61H 1/02; B25J 9/0006; B25J 9/14; A61H 2201/165; A61H 2230/605

(57) ABSTRACT

A method of controlling a pneumatic muscle device through an electromyographic signal including: obtaining electromyographic signals currently generated by each of the target muscles of the wearer of the pneumatic muscle device; determining a behavior classification of the wearer of the pneumatic muscle device according to all of the electromyographic signals and a preset neural network model, and the neural network model is trained and obtained according to historical electromyographic signals generated by each of the target muscles; determining a driving amount corresponding to each of the target muscles according to the behavior classification of the wearer of the pneumatic muscle device; and driving the simulated muscles corresponding to each of the target muscles according to the driving amount corresponding to each of target muscles.

### CROSS REFERENCE TO RELATED APPLICATION

The present application claims priority of a Chinese patent application, with application No. 202310952647.3, filed on Jul. 31, 2023; the contents of which are incorporated herein by reference.

### TECHNICAL FIELD

The present application relates to the technical field of computer applications and, more specifically, to a method and a device of controlling a pneumatic muscle device through an electromyographic signal, a terminal apparatus, and a computer-readable storage medium.

### BACKGROUND

In recent years, pneumatic muscle technology has made significant progress in the fields of robotics and biomedical engineering, especially in the application of biomedical engineering. It can be used to develop rehabilitation equipment to assist damaged human limbs in completing daily movements. In addition, pneumatic muscles can also be used for biomimetic prosthetics and exoskeleton devices, which provide more natural and flexible motion control methods.

In related technologies, most methods of using pneumatic muscles to control exoskeletons use preset action signals to control the pneumatic muscles and further achieve control of the entire exoskeleton. However, using preset action signals to control the pneumatic muscles can cause significant hysteresis in muscle contraction compared to muscle activation or action intention generated by the central nervous system. Thus, the accuracy and the experience of the wearer in the controlling of the pneumatic muscle device are reduced.

### SUMMARY

Embodiments of the present application provide a method and a device for controlling a pneumatic muscle device through an electromyographic signal, a terminal apparatus, and a computer-readable storage medium, which can solve the problem that the preset action signal is commonly used to control the pneumatic muscle device in the current control method of the pneumatic muscle device, thereby resulting in poor accuracy and individuation of the wearer on the control method of the pneumatic muscle device.

In accordance with the first aspect of an embodiment of the present application, a method of controlling a pneumatic muscle device through an electromyographic signal is provided, which includes obtaining electromyographic signals currently generated by each of the target muscles of the wearer of the pneumatic muscle device; determining a behavior classification of the wearer of the pneumatic muscle device according to all of the electromyographic signals and a preset neural network model, and the neural network model is trained and obtained according to historical electromyographic signals generated by each of the target muscles; determining a driving amount corresponding to each of the target muscles according to the behavior classification of the wearer of the pneumatic muscle device; and driving the simulated muscles corresponding to each of the target muscles according to the driving amount corresponding to each of target muscles.

In one possible implementation of the first aspect, the step of determining the behavior classification of the wearer of the pneumatic muscle device according to all of the electromyographic signals and the preset neural network model includes:
determining a corresponding muscle strength signal according to the electromyographic signals and a preset muscle mechanics model; and
inputting the corresponding muscle strength signal into the neural network model to determine the behavior classification corresponding to each of the target muscles.

Optionally, in another possible implementation of the first aspect, the muscle mechanics model includes an activation function layer, a first computational layer, a second computational layer, and an output layer; and the step of determining the corresponding muscle strength signal according to the electromyographic signals and the preset muscle mechanics model includes:
inputting the electromyographic signals into the activation function layer, in which the activation function layer outputs corresponding muscle activation level information;
inputting length data of each of the target muscles into the first computational layer, in which the first computational layer outputs a corresponding first force predicted value;
inputting contraction speed data of each of the target muscles into the second computational layer, in which the second computational layer outputs a corresponding second force predicted value; and
inputting the muscle activation level information, the first force predicted value, and the second force predicted value into the output layer, in which the output layer outputs the corresponding muscle strength signal.

Optionally, in a further possible implementation of the first aspect, the step of driving the simulated muscles corresponding to each of the target muscles according to the driving amount corresponding to each of the target muscles includes:
sending the driving amount to an embedded system to generate a drive voltage corresponding to the simulated muscle of each of the target muscles; and
outputting the drive voltage to a voltage terminal of the simulated muscle corresponding to the drive voltage.

Optionally, in a yet possible implementation of the first aspect, after inputting the electromyographic signals into the activation function layer, and the activation function layer outputs corresponding muscle activation level information, the method further includes:
generating a muscle activation level distribution map according to the muscle activation level information of each of the target muscles; and
sending the muscle activation level distribution map to a display terminal designated by the wearer, to display the muscle activation level distribution map on the display terminal.

Optionally, in a yet possible implementation of the first aspect, the method further includes:
collecting curvature data and the electromyographic signals corresponding to each of the target muscles of the wearer; and
calibrating the muscle mechanics model according to the curvature data and the electromyographic signals.

In accordance to a second aspect of an embodiment of the present application, a device of controlling a pneumatic muscle device through an electromyographic signal is provided, which includes: an obtaining module configured to obtain electromyographic signals currently generated by each of the target muscles of the wearer of the pneumatic muscle device; a first determination module configured to determine a behavior classification of the wearer of the pneumatic muscle device according to all of the electromyographic signals and a preset neural network model, in which the neural network model is trained and obtained according to historical electromyographic signals generated by each of the target muscles; a second determination module configured to determine a driving amount corresponding to each of the target muscles according to the behavior classification of the wearer of the pneumatic muscle device; and a drive module configured to drive the simulated muscles corresponding to each of the target muscles according to the driving amount corresponding to each of target muscles.

In one possible implementation of the second aspect, the first determination module includes:
a first determination unit configured to determine a corresponding muscle strength signal according to the electromyographic signals and a preset muscle mechanics model; and
a second determination unit configured to input the corresponding muscle strength signals into the neural network model to determine the behavior classification corresponding to each of the target muscles.

Optionally, in another possible implementation of the second aspect, the muscle mechanics model includes an activation function layer, a first computational layer, a second computational layer, and an output layer; and correspondingly, the first determination unit is configured explicitly for:
inputting the electromyographic signals into the activation function layer, in which the activation function layer outputs corresponding muscle activation level information;
inputting length data of each of the target muscles into the first computational layer, in which the first computational layer outputs a corresponding first force predicted value;
inputting contraction speed data of each of the target muscles into the second computational layer, in which the second computational layer outputs a corresponding second force predicted value; and
inputting the muscle activation level information, the first force predicted value, and the second force predicted value into the output layer, in which the output layer outputs the corresponding muscle strength signal.

Optionally, in a further possible implementation of the second aspect, the drive module includes:
a first generation unit configured to send the driving amount to an embedded system to generate a drive voltage corresponding to the simulated muscle of each of the target muscles; and
a first output unit configured to output the drive voltage to a voltage terminal of the simulated muscle corresponding to the drive voltage.

Optionally, in a yet possible implementation of the second aspect, before the first obtaining module, the device further includes:
a second obtaining module configured to obtain electromyographic signals to be processed generated by each of the target muscles of the wearer; and
a signal processing module configured to perform signal processing on the electromyographic signals to be processed to obtain the electromyographic signals.

Optionally, in a yet possible implementation of the second aspect, the first determination unit is further specifically configured for:
generating a muscle activation level distribution map according to the muscle activation level information of each of the target muscles; and
sending the muscle activation level distribution map to a display terminal designated by the wearer, to display the muscle activation level distribution map on the display terminal.

Optionally, in a yet possible implementation of the second aspect, the device further includes:
a collecting module configured to collect curvature data and the electromyographic signals corresponding to each of the target muscles of the wearer; and
a calibrating module configured to calibrate the muscle mechanics model according to the curvature data and the electromyographic signals.

In accordance with a third aspect of an embodiment of the present application, a terminal apparatus is provided, which includes memory, a processor, and a computer program stored in the memory and capable of running on the processor which, when executed by the processor, cause the processor to perform the method of controlling a pneumatic muscle device through an electromyographic signal.

In accordance with a fourth aspect of an embodiment of the present application, a computer-readable storage medium is provided, which stores a computer program which, when executed by a processor, causes the processor to perform the method of controlling a pneumatic muscle device through an electromyographic signal.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a schematic flow chart of a method of controlling a pneumatic muscle device through an electromyographic signal provided by an embodiment of the present application;

FIG. 2 is a schematic flow chart of a method of controlling a pneumatic muscle device through an electromyographic signal provided by another embodiment of the present application;

FIG. 3 is a schematic flow chart of a method of controlling a pneumatic muscle device through an electromyographic signal provided by a further embodiment of the present application;

FIG. 4 is a schematic flow chart of a method of controlling a pneumatic muscle device through an electromyographic signal provided by a yet embodiment of the present application;

FIG. 5 is a schematic flow chart of a method of controlling a pneumatic muscle device through an electromyographic signal provided by a yet embodiment of the present application;

FIG. 6 is a schematic flow chart of a device of controlling a pneumatic muscle device through an electromyographic signal provided by an embodiment of the present application; and

FIG. 7 is a schematic diagram of a terminal apparatus provided by an embodiment of the present application.

### DETAILED DESCRIPTION OF EMBODIMENTS

In the following description, specific details, such as specific system structure, technology, etc., are presented for illustration rather than qualification in order to understand the embodiments of the present application fully. However, it should be clear to those skilled in the art that the present application may also be realized in other embodiments without these specific details. In other cases, detailed descriptions of well-known systems, devices, circuits and methods are omitted so as to prevent the description of the present application from being confused by unnecessary details.

It should be understood that when used in the present application description and the accompanying claims, the term “includes” indicates the existence of the features, wholes, steps, operations, elements and/or components described, but does not exclude the existence or addition of one or more other features, wholes, steps, operations, elements, components and/or collections thereof.

It should also be understood that the term “and/or” as used in the description of the present application and the accompanying claims means any combination of one or more of the items listed in relation to them and all possible combinations thereof, and includes such combinations.

As used in the description of the present application and the accompanying claims, the term “if” may be construed in the context to mean “when . . . ” or “once” or “in response to determination” or “in response to detection”. Similarly, the phrase “if determined” or “if the described condition or event is detected” can be interpreted, depending on the context, to mean “once determined” or “in response to determined” or “once the described condition or event is detected” or “in response to detected the described condition or event”.

In addition, the terms “first”, “second”, “third”, etc. in the description of the present application and the accompanying claims are used only to distinguish the description and are not to be construed as indicating or implying relative importance.

References to “one embodiment” or “some embodiments”, etc. as described in the description of the present application means that specific features, structures, or features described in conjunction with the embodiments are included in one or more embodiments of the present application. Thus, the terms “in one embodiment”, “in some embodiments”, “in some other embodiments”, “in some further embodiments”, etc., which appear in differences in the specification, do not necessarily all refer to the same embodiments, but mean “one or more but not all embodiments” unless otherwise specifically emphasized. The terms “including”, “containing”, “having” and their variations all mean “including but not limited to” unless otherwise specifically emphasized.

The method and a device of controlling a pneumatic muscle device through an electromyographic signal, a terminal apparatus, and a computer-readable storage medium provided in the present application are described in detail with reference to the attached drawings.

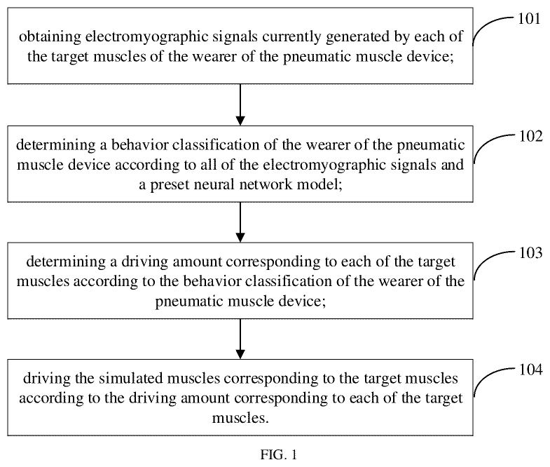

FIG. 1 shows a schematic flow chart of a method of controlling a pneumatic muscle device through an electromyographic signal provided in the embodiment of the present application.

In a step 101, electromyographic signals are obtained that are currently generated by each of the target muscles of the wearer of the pneumatic muscle device.

In the embodiment, pneumatic muscles can refer to an artificial muscle technology, which is a device based on pneumatic principles used to simulate the contraction and extension movements of human muscles.

In the embodiment, electromyographic signals can refer to electrical signals generated by muscles, which generate weak electrical activity during contraction and extension. For example, electromyographic signals can be surface electromyographic signals and immersion electromyographic signals, and electromyographic signals can be recorded and analyzed through electromyography.

In the embodiment of the present application, the electromyographic signals corresponding to the target muscles of the wearer of the pneumatic muscle device can be first collected, and then the behavior classification of the wearer of the pneumatic muscle device can be determined based on the collected electromyographic signals.

In a step 102, a behavior classification of the wearer of the pneumatic muscle device is determined according to all of the electromyographic signals and a preset neural network model.

In the embodiment, the behavior classification can refer to the neural network model analyzing and predicting input data, dividing the input data into different behavior categories or labels. Through learning and training, the neural network model can classify the input data into different behavior or action categories based on the characteristics of the input data.

For example, when the target muscle is a whole back muscle, the electromyographic signals generated by the back muscle during different movements (such as bending, straightening, etc.) are collected, and then the electromyographic signals are input into the neural network model. After learning and training, the neural network model will classify different electromyographic signals into different behavioral categories based on the electromyographic signals generated by the back muscles, such as classifying a certain electromyographic signal as bending behavior.

It should be noted that the neural network model is trained based on the historical electromyographic signals generated by each of the target muscles, and the historical electromyographic signals generated by each of the target muscles are used as the training set to train the neural network model.

For example, the preset neural network models include but are not limited to feedforward neural networks, convolutional neural networks, and recurrent neural networks.

In the embodiment of the present application, all electromyographic signals generated by the target muscles of the wearer of the pneumatic muscle device can be obtained, and combined with a preset neural network model, the behavior classification of the wearer of the pneumatic muscle device can be determined. Furthermore, the corresponding driving amount of each of the target muscles of the wearer can be determined based on the behavior classification.

In a step 103, a driving amount corresponding to each of the target muscles is determined according to the behavior classification of the wearer of the pneumatic muscle device.

In the embodiment, the driving amount of muscles can refer to the strength or activity level generated by muscles, and the driving amount is used to control and execute movement tasks.

It should be noted that the driving amount of muscles can be expressed in different ways, such as muscle strength, muscle activity level, muscle contraction level, etc.; which is not limited herein.

In an embodiment of the present application, after the behavior classification of the wearer of the pneumatic muscle device is determined, the driving amount corresponding to each of the target muscles of the wearer of the pneumatic muscle device can be determined based on the above behavior classification; therefore, the simulated muscles corresponding to each of the target muscles are controlled based on the driving amount corresponding to each of the target muscles.

In a step 104, the simulated muscles is driven corresponding to each of the target muscles according to the driving amount corresponding to each of the target muscles.

In the embodiment, the simulated muscles can refer to the muscle sub-units that make up the pneumatic muscle device.

In an embodiment of the present application, after the driving amount corresponding to each of the target muscles of the wearer of the pneumatic muscle device is obtained, the simulated muscles corresponding to each of the target muscles are driven according to the above driving amount; therefore the control of the pneumatic muscle device is achieved.

In the method of controlling the pneumatic muscle device through the electromyographic signals provided in the present application, the electromyographic signals currently generated by each of the target muscles of the wearer of the pneumatic muscle device are obtained, the behavior classification of the wearer of the pneumatic muscle device is then determined according to all of the electromyographic signals and the preset neural network model, the driving amount corresponding to each of the target muscles is then determined according to the behavior classification of the wearer of the pneumatic muscle device, and finally, the simulated muscles corresponding to each of the target muscles are driven according to the driving amount corresponding to each of target muscles. Therefore, the driving amount corresponding to the behavior classification of the wearer is obtained by obtaining the electromyographic signals and combining the electromyographic signals with the preset neural network model. The control of the pneumatic muscle device can be achieved according to the simulated muscles controlled by the driving amount, the accuracy of the control method of the pneumatic muscle device is improved, the personalized control method of the pneumatic muscle device is enhanced, and the user experience of the wearer is enhanced.

In one possible implementation of the present application, the electromyographic signals can also be input into the muscle mechanics model to output the muscle strength signals, and then the muscle strength signals can be combined with the preset neural network model to determine the corresponding behavior classification of each of the target muscles. Therefore, the control method of the pneumatic muscle device can be optimized, the effectiveness of the motion control of the wearer is improved, and the user experience of the wearer is enhanced.

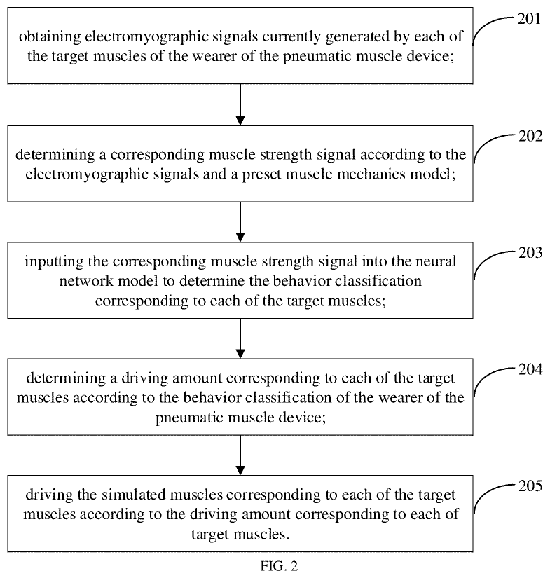

The following is a further explanation of the method of controlling the pneumatic muscle device through the electromyographic signal provided in the embodiment of the present application, in conjunction with FIG. 2.

FIG. 2 shows a schematic flowchart of another method of controlling the pneumatic muscle device through the electromyographic signal provided in the embodiment of the present application.

In a step 201, electromyographic signals currently generated by each of the target muscles of the wearer of the pneumatic muscle device are obtained.

The specific implementation process and principle of step 201 above can be referred to the detailed description of the above embodiments, which will not be repeated here.

In a step 202, a corresponding muscle strength signal is determined according to the electromyographic signals and a preset muscle mechanics model.

In the embodiment, the muscle mechanics model can refer to a mathematical model used to describe muscle movement and mechanical properties; which is based on the understanding of the structure and function of the muscle tissue, and establishes a series of equations and parameters to simulate and predict the strength output, activity level, force length characteristics, force velocity characteristics, etc. of the muscle.

It should be noted that muscle mechanics models can include the Hill model, step reaction model, delayed reaction model, and simulated muscle model, etc. The present application does not limit this.

In the embodiment, the muscle strength signal can refer to the estimated strength output value corresponding to the target muscles that generate the electromyographic signals.

In the embodiment of the present application, after the electromyographic signals of the wearer are obtained, the electromyographic signals can be input into the preset muscle mechanics model, and then the muscle mechanics model will output the muscle strength signal corresponding to the electromyographic signals, therefore the muscle strength signal is input into the neural network model to determine the behavior classification corresponding to each of the target muscles.

Furthermore, in one possible implementation of the embodiment of the present application, the muscle mechanics model includes an activation function layer, a first computational layer, a second computational layer, and an output layer. The above step 202 can include:
inputting the electromyographic signals into the activation function layer, in which the activation function layer outputs corresponding muscle activation level information.

In the embodiment, the activation function layer can refer to the layer in the muscle mechanics model that uses the activation function to calculate the activation level corresponding to the electromyographic signals. For example, the activation function can include a linear function, a threshold function, a smoothing function, etc.; which is not limited herein.

In the embodiment, the activation level of muscle can refer to the activation level of muscle within a specific time. For example, a higher activation level indicates that the muscle is more active, while a lower activation level indicates that the muscle is stationary.

In the embodiment of the present application, the obtained electromyographic signal can be input into the activation function layer of the muscle mechanics model, and then the muscle activation level information corresponding to the electromyographic signals output by the activation function layer can be used as one of the conditions for determining the muscle strength signal.

Furthermore, in one possible implementation of the embodiment of the present application, after the above steps, the method can further include:
generating a muscle activation level distribution map according to the muscle activation level information of each of the target muscles.

In the embodiment, the muscle activation level distribution map can refer to a graphical representation used to visualize the activation level of different muscles or muscle groups within a specific time.

For example, the horizontal axis of the muscle activation level distribution map represents time, and the vertical axis represents the activation level of muscles or muscle groups. The activation level of each muscle or muscle group can be represented using different indicators, such as the amplitude, root mean square value, frequency component, etc., of the electromyographic signal.

It should be noted that in addition to the horizontal and vertical axes representing the distribution map of muscle activation levels, different forms such as line graphs, area graphs, and heat maps can also be used to represent the distribution map of muscle activation levels; which is not limited herein.

The muscle activation level distribution map is sent to the designated display terminal of the wearer, so that the display terminal can provide real-time feedback on the muscle activation level distribution map to the wearer.

In the embodiment of the present application, the muscle activation level distribution map can be generated based on the activation level information of each of the target muscles. The wearer can timely understand the muscle activation situation during exercise by converting the activation level information into visual information and sending the visual information to the designated display terminal of the wearer, which helps users adjust the muscle coordination mode to achieve better performance of the pneumatic muscle device.

The length data of each of the target muscles is input into the first computational layer, in which the first computational layer outputs the corresponding first force predicted value.

In the embodiment, the first force predicted value can refer to the force output generated by muscles at different lengths.

It should be noted that the muscle length of the target muscle needs to be measured first. The muscle length is then input into the fitted muscle length-tension characteristic curve equation to calculate the force output corresponding to the muscle length, and the force output is the first force predicted value.

In the embodiment of the present application, the obtained muscle length can be input into the first computational layer of the muscle mechanics model, and then the first force predicted value corresponding to the electromyographic signals output by the first computational layer can be used as one of the conditions for determining the muscle strength signal.

The contraction speed data of each of the target muscles is input into the second computational layer, in which the second computational layer outputs the corresponding second force predicted value.

In the embodiment, the second force predicted value can refer to the force output generated by the muscle at different contraction speeds.

It should be noted that the contraction speed of the target muscle needs to be measured first. The contraction speed is then input into the fitted muscle speed-force characteristic curve equation to calculate the force output corresponding to the muscle contraction speed, and the force output is the second force predicted value.

In the embodiment of the present application, the obtained muscle contraction speed can be input into the second computational layer of the muscle mechanics model, and then the second force predicted value corresponding to the electromyographic signals output by the second computational layer can be used as one of the conditions for determining the muscle strength signal.

The muscle activation level information, the first force predicted value, and the second force predicted value are input into the output layer, and the output layer outputs the corresponding muscle strength signal.

In the embodiment of the present application, the muscle activation level information, the first force predicted value, and the second force predicted value can be input into the output layer of the muscle mechanics model for calculation, so as to obtain the corresponding muscle strength signal. Furthermore, the muscle strength signal can be input into the neural network model to determine the behavior classification corresponding to each of the target muscles.

In a step 203, the muscle strength signal is input into the neural network model to determine the corresponding behavioral classification for each of the target muscles.

In the embodiment of the present application, after the muscle strength signal is obtained, the muscle strength signal can be input into the neural network model to determine the behavior classification corresponding to each of the target muscles, and then the driving amount corresponding to each of the target muscles can be determined based on the behavior classification.

In a step 204, a driving amount corresponding to each of the target muscles is determined according to the behavior classification of the wearer of the pneumatic muscle device.

In a step 205, the simulated muscles corresponding to each of the target muscles is driven according to the driving amount corresponding to each of the target muscles.

The specific implementation process and principle of steps 204-205 above can refer to the detailed description of the above embodiments, which will not be repeated here.

The method of controlling the pneumatic muscle device through the electromyographic signal provided in the present application obtains the electromyographic signals currently generated by each of the target muscles of the wearer of the pneumatic muscle device; the corresponding muscle strength signal is then determined according to the electromyographic signals and the preset muscle mechanics model, the muscle strength signal is input into the neural network model to determine the corresponding behavior classification, the driving amount corresponding to each of the target muscles is then determined according to the behavior classification of the wearer of the pneumatic muscle device, and the simulated muscles corresponding to each of the target muscles are finally driven according to the driving amount corresponding to each of the target muscles. Therefore, by inputting the electromyographic signals into the muscle mechanics model to obtain the muscle strength signal, and then inputting the muscle strength signal into the neural network model to obtain the corresponding driving amount of the target muscle to drive the corresponding simulated muscle, the method of controlling the pneumatic muscle device can be more accuracy, while also improving the user experience of the wearer.

In one possible implementation of the present application, after the driving amount corresponding to each of the target muscles is obtained, the driving amount can be sent to the embedded system, and then the embedded system can be used to control the simulated muscles. By sending the driving amount to the embedded system, the pneumatic muscle device can be controlled, more accuracy and personalized control can be achieved, and the user experience is enhanced.

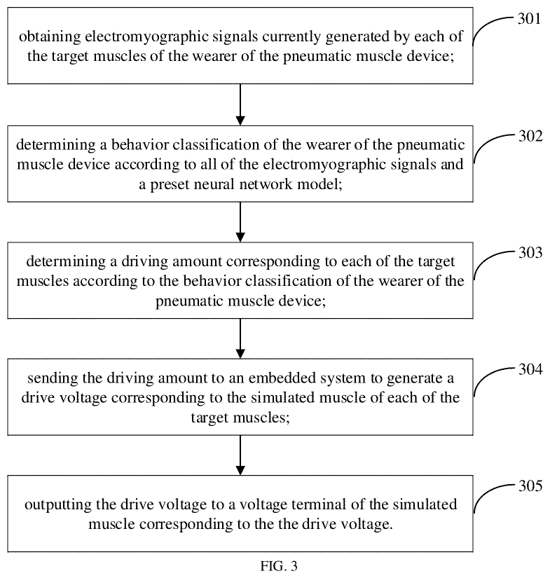

The following is a further explanation of the method of controlling the pneumatic muscle device through the electromyographic signal provided in the embodiment of the present application, in conjunction with FIG. 3.

FIG. 3 shows a schematic flow chart of another method of controlling the pneumatic muscle device through the electromyographic signal provided in the embodiment of the present application.

In a step 301, electromyographic signals currently generated by each of the target muscles of the wearer of the pneumatic muscle device are obtained.

In a step 302, a behavior classification of the wearer of the pneumatic muscle device is determined according to all of the electromyographic signals and a preset neural network model.

In a step 303, a driving amount corresponding to each of the target muscles is determined according to the behavior classification of the wearer of the pneumatic muscle device.

The specific implementation process and principle of steps 301-302 above can refer to the detailed description of the above embodiments, which will not be repeated here.

In a step 304, the driving amount is sent to an embedded system to generate a drive voltage corresponding to the simulated muscle of each of the target muscles.

As one possible implementation method, the driving amount can be converted into an appropriate data format, and the data transmission of the driving amount can be achieved using the serial communication library or related wireless communication library in the embedded system, the input and output pins of the embedded system can then be used to connect the received data to the appropriate output pins; the simulated muscles can be controlled through the output pins of the embedded system according to the content and logic of the data.

For example, embedded systems can be Arduino systems, embedded industrial control computers, etc., and these are not limited herein.

In the embodiment of the present application, the driving amount corresponding to each of the target muscles can be obtained first, and the driving amount can then be sent to the embedded system to obtain the drive voltage of the simulated muscle corresponding to each of the target muscles. The drive voltage can then be sent to the voltage terminal of the simulated muscle.

In a step 305, the drive voltage is output to a voltage terminal of the simulated muscle corresponding to the drive voltage.

In the embodiment of the present application, the simulated muscle can be controlled after a drive voltage at the voltage terminal of the simulated muscle is obtained.

The method of controlling the pneumatic muscle device through the electromyographic signals provided in the present application obtains the electromyographic signals currently generated by each of the target muscles of the wearer of the pneumatic muscle device; the behavior classification of the wearer of the pneumatic muscle device is then determined according to all of the electromyographic signals and the preset neural network model; the driving amount corresponding to each of the target muscles is then determined according to the behavior classification of the wearer of the pneumatic muscle device; the driving amount is then sent to the embedded system to generate the drive voltage of the simulated muscle corresponding to each of the target muscles; and finally, the drive voltage is output to the voltage terminal of the corresponding simulated muscle. Therefore, by sending the driving amount to the embedded system and then using the embedded system to control the simulated muscles, the method of controlling the pneumatic muscle device can be more accurate and personalized, and the user experience is enhanced.

In one possible implementation of the present application, the collected electromyographic signals to be processed can also be processed before the electromyographic signals of each of the target muscles are obtained, so as to reduce unnecessary noise and interference, and to better analyze and analyze the signals subsequently.

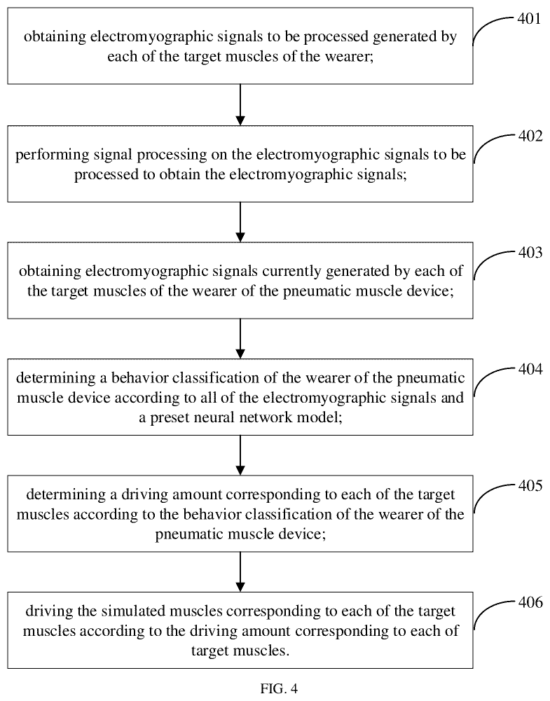

The following is a further explanation of the method of controlling the pneumatic muscle device through the electromyographic signal provided in the embodiment of the present application, in conjunction with FIG. 4.

FIG. 4 shows a schematic flow chart of another method of controlling the pneumatic muscle device through the electromyographic signal provided in the embodiment of the present application.

In a step 401, electromyographic signals to be processed generated by each of the target muscles of the wearer are obtained.

In the embodiment of the present application, the electromyographic signals to be processed generated by each of the target muscles of the wearer can be obtained and processed to obtain the electromyographic signals.

In a step 402, signal processing is performed on the electromyographic signals to be processed to obtain the electromyographic signals.

It should be noted that signal processing on the electromyographic signals to be processed can include filtering, amplifying, and denoising the processed electromyographic signals; and the filtering can remove high-frequency noise and interference, the amplifying can enhance signal amplitude, and the denoising can reduce artifacts in the signal; which is not limited herein.

In the embodiment of the present application of the application, signal processing can be performed on the electromyographic signals to be processed to obtain the corresponding electromyographic signals. By pre-processing the electromyographic signals, the quality, accuracy, and interpretability of the electromyographic signals can be improved, which provides a more reliable foundation for subsequent signal processing and analysis tasks.

In a step 403, electromyographic signals currently generated by each of the target muscles of the wearer of the pneumatic muscle device are obtained.

In a step 404, a behavior classification of the wearer of the pneumatic muscle device is determined according to all of the electromyographic signals and a preset neural network model.

In a step 405, a driving amount corresponding to each of the target muscles is determined according to the behavior classification of the wearer of the pneumatic muscle device.

In a step 406, the simulated muscles corresponding to each of the target muscles is driven according to the driving amount corresponding to each of the target muscles.

The specific implementation process and principle of steps 403-406 above can be referred to the detailed description of the above embodiments, which will not be repeated herein.

In the method of controlling the pneumatic muscle device through the electromyographic signals provided in the present application, the electromyographic signals currently generated by each of the target muscles of the wearer of the pneumatic muscle device are obtained, the electromyographic signals to be processed are then performed by signal processing to obtain the electromyographic signals, the electromyographic signals currently generated by each of the target muscles of the wearer of the pneumatic muscle device are then obtained, the behavior classification of the wearer of the pneumatic muscle device is then determined according to all of the electromyographic signals and the preset neural network model, the driving amount corresponding to each of the target muscles is then determined according to the behavior classification of the wearer of the pneumatic muscle device, and finally the simulated muscles corresponding to each of the target muscles are driven according to the driving amount corresponding to each of target muscles. Therefore, by signal processing the electromyographic signals to be processed to obtain the electromyographic signals, the quality and accuracy of the electromyographic signals are improved. At the same time, the methods for controlling the pneumatic muscle device are more accurate and personalized, and the user experience of the wearer is enhanced.

In one possible implementation of the present application, the method of controlling the pneumatic muscle device can also be more accurate and personalized by calibrating the muscle mechanics model.

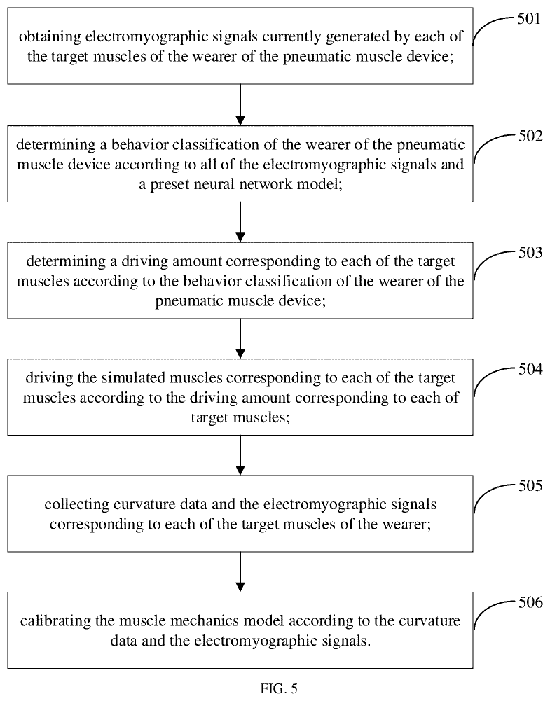

The method of controlling the pneumatic muscle device through the electromyographic signal provided in the embodiment of the present application is further described below, with reference to FIG. 5.

FIG. 5 illustrates a schematic flow chart of another method of controlling the pneumatic muscle device through the electromyographic signal provided in the embodiment of the present application.

In a step 501, electromyographic signals currently generated by each of the target muscles of the wearer of the pneumatic muscle device are obtained.

In a step 502, a behavior classification of the wearer of the pneumatic muscle device is determined according to all of the electromyographic signals and a preset neural network model.

In a step 503, a driving amount corresponding to each of the target muscles is determined according to the behavior classification of the wearer of the pneumatic muscle device.

In a step 504, the simulated muscles corresponding to each of the target muscles is driven according to the driving amount corresponding to each of the target muscles.

The specific implementation process and principle of steps 501-504 above can be referred to the detailed description of the above embodiments, which will not be repeated herein.

In a step 505, curvature data and the electromyographic signals corresponding to each of the target muscles of the wearer are collected.

In the embodiment, the curvature data can refer to measurement data of joint angles or muscle lengths related to muscle movement, these data are used to describe the changes in muscle movement and the stretching and contraction of muscle length; which is not limited herein.

In the embodiment of the present application, the muscle mechanics model can be calibrated based on the curvature data and electromyographic signals after the curvature data and electromyographic signals corresponding to each of the target muscles of the wearer are obtained.

In a step 506, the muscle mechanics model is calibrated according to the curvature data and the electromyographic signals.

It should be noted that when parameters in the muscle mechanics model are calibrated, the muscle curvature data is used to correspond with the electromyographic signals to establish the relationship between the electromyographic signals and muscle strength signals. By recording the muscle curvature data, the force output of muscles at different bending degrees can be understood, therefore, the parameters of muscle mechanics models are optimized and the parameters are enabled to output muscle strength signals more accurately.

In the embodiment of the present application, the muscle mechanics model can be calibrated according to the curvature data and the electromyographic signals to enable the wearer to control the pneumatic muscle device more accurately.

The method of controlling the pneumatic muscle device through electromyographic signals provided in this application obtains the electromyographic signals currently generated by each target muscle of the wearer of the pneumatic muscle device; the behavior classification of the wearer of the pneumatic muscle device is then determined according to all of the electromyographic signals and the preset neural network model, the driving amount corresponding to each of the target muscles is then determined according to the behavior classification of the wearer of the pneumatic muscle device, the simulated muscles corresponding to each of the target muscles are then driven according to the driving amount corresponding to each of target muscles, the curvature data and electromyographic signals corresponding to each of the target muscles of the wearer are then collected, and finally, the muscle mechanics model is calibrated according to the curvature data and the electromyographic signals. Therefore, by calibrating the muscle mechanics model, the accuracy of the control to the pneumatic muscle device is improved, and the user experience of the wearer is enhanced.

It should be understood that the size of the sequence numbers of each step in the above embodiments does not imply the order of execution. The execution order of each process should be determined by its function and internal logic. It should not constitute any limitation on the implementation process of the embodiment of the present application.

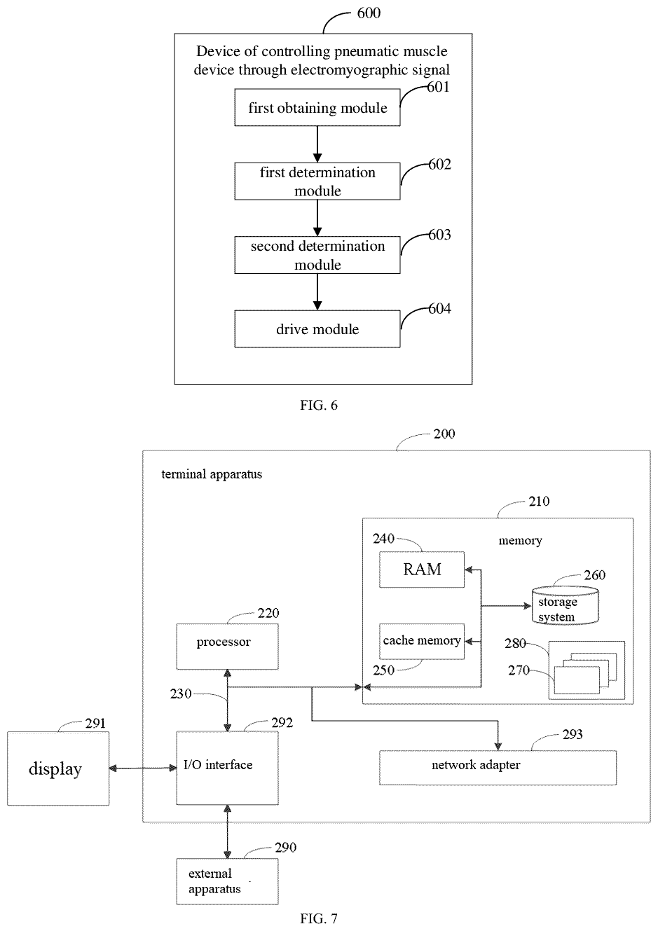

Corresponding to the method of controlling the pneumatic muscle device through the electromyographic signal in the previous embodiments, FIG. 6 shows the structural diagram of the device of controlling the pneumatic muscle device through the electromyographic signal provided in the embodiment of the present application. For ease of illustration, only the relevant parts of the embodiment of the present application are shown.

As shown in FIG. 6, the device 600 includes:
a first obtaining module 601, configured to obtain electromyographic signals currently generated by each of the target muscles of the wearer of the pneumatic muscle device;
a first determination module 602, configured to determine a behavior classification of the wearer of the pneumatic muscle device according to all of the electromyographic signals and a preset neural network model, in which the neural network model is trained and obtained according to historical electromyographic signals generated by each of the target muscles;
a second determination module 603, configured to determine a driving amount corresponding to each of the target muscles according to the behavior classification of the wearer of the pneumatic muscle device; and
a drive module 604, configured to drive the simulated muscles corresponding to each of the target muscles according to the driving amount corresponding to each of the target muscles.

In practical use, the device of controlling the pneumatic muscle device through the electromyographic signal provided in the embodiment of the present application can be configured in any terminal apparatus to perform the method of controlling the pneumatic muscle device through the electromyographic signals as described above.

In the device of controlling the pneumatic muscle device through the electromyographic signals provided in the present application, the electromyographic signals currently generated by each of the target muscles of the wearer of the pneumatic muscle device are obtained, then the behavior classification of the wearer of the pneumatic muscle device is determined according to all of the electromyographic signals and the preset neural network model, then the driving amount corresponding to each of the target muscles is determined according to the behavior classification of the wearer of the pneumatic muscle device, and finally the simulated muscles corresponding to each of the target muscles are driven according to the driving amount corresponding to each of target muscles. Therefore, the driving amount corresponding to the behavior classification of the wearer is obtained by obtaining the electromyographic signals and combining the electromyographic signals with the preset neural network model, then the control of the pneumatic muscle device can be achieved according to the simulated muscles controlled by the driving amount, the accuracy of the control method of the pneumatic muscle device is improved, the personalized control method of the pneumatic muscle device is enhanced, and the user experience of the wearer is enhanced.

In one possible implementation of the embodiment of the present application, the first determination module 602 includes:
a first determination unit configured to determine a corresponding muscle strength signal according to the electromyographic signals and a preset muscle mechanics model; and
a second determination unit configured to input the corresponding muscle strength signal into the neural network model to determine the behavior classification corresponding to each of the target muscles.

Furthermore, in another possible implementation of the embodiment of the present application, the muscle mechanics model includes an activation function layer, a first computational layer, a second computational layer, and an output layer; and correspondingly, the first determination unit is specifically configured to:
input the electromyographic signals into the activation function layer, in which the activation function layer outputs corresponding muscle activation level information;
input length data of each of the target muscles into the first computational layer, in which the first computational layer outputs a corresponding first force predicted value;
input contraction speed data of each of the target muscles into the second computational layer, in which the second computational layer outputs a corresponding second force predicted value; and
input the muscle activation level information, the first force predicted value, and the second force predicted value into the output layer, in which the output layer outputs the corresponding muscle strength signal.

Furthermore, in another possible implementation of the embodiment of the present application, the above-mentioned drive module 604 includes:
a first generation unit configured to send the driving amount to an embedded system to generate a drive voltage corresponding to the simulated muscle of each of the target muscles; and
a first output unit configured for output the drive voltage to a voltage terminal of the simulated muscle corresponding to the drive voltage.

Furthermore, in another possible implementation of the embodiment of the present application, the above-mentioned device 600 further includes:
a second obtaining module 605, configured to obtain electromyographic signals to be processed generated by each of the target muscles of the wearer; and
a signal processing module 606, configured to perform signal processing on the electromyographic signals to be processed to obtain the electromyographic signals.

Furthermore, in another possible implementation of the embodiment of the present application, the first determination unit mentioned above is configured explicitly to:
generate a muscle activation level distribution map according to the muscle activation level information of each of the target muscles; and
send the muscle activation level distribution map to a display terminal designated by the wearer, to display the muscle activation level distribution map on the display terminal.

Furthermore, in another possible implementation of the embodiment of the present application, the above-mentioned device 600 further includes:
a collecting module 607, configured to collect curvature data and the electromyographic signals corresponding to each of the target muscles of the wearer; and
a calibrating module 608, configured to calibrate the muscle mechanics model according to the curvature data and the electromyographic signals.

It should be noted that the information interaction and execution process between the above-mentioned devices/units are based on the same concept as the embodiments of a method of the present application. The specific functions and technical effects can be found in the embodiments section of the method, and will not be repeated herein.

It can be clearly understood by those skilled in the art that, for describing conveniently and concisely, dividing of the aforesaid various functional units, functional modules is described exemplarily merely, in an actual application, the aforesaid functions can be assigned to different functional units and functional modules to be accomplished, that is, an inner structure of a data synchronizing device is divided into functional units or modules so as to accomplish the whole or a part of functionalities described above. The various functional units and modules in the embodiments can be integrated into a processing unit, or each of the units exists independently and physically, or two or more of the units are integrated into a single unit. The aforesaid integrated unit can be actualized either in the form of hardware or in the form of functional software units. In addition, specific names of the various functional units and modules are only used for distinguishing from each other conveniently, but not intended to limit the protection scope of the present application. Regarding a specific working process of the units and modules in the aforesaid device, reference can be made to a corresponding process in the aforesaid method embodiments, which is not repeatedly described herein.

In order to achieve the above embodiments, the present application also proposes a terminal apparatus.

FIG. 7 is a schematic diagram of a terminal apparatus in one embodiment of the present application.

As shown in FIG. 7, the above terminal apparatus 200 includes:
a memory 210, at least one processor 220, and a bus 230 connected to different components (including the memory 210 and the processor 220), the memory 210 stores computer programs, and implements the method of controlling the pneumatic muscle device through the electromyographic signal as described in the embodiments of the present application when processor 220 executes the computer programs.

The bus 230 represents one or more types of bus structures, including memory buses or memory controllers, peripheral buses, graphics acceleration ports, processors, or local area buses using any of the various bus structures. For example, these architectures include but are not limited to Industry Standard Architecture (ISA) buses, Microchannel Architecture (MAC) buses, Enhanced ISA buses, Video Electronics Standards Association (VESA) local area buses, and Peripheral Component Interconnection (PCI) buses.

The terminal apparatus 200 typically includes multiple electronic device readable mediums. These mediums can be any available mediums that can be accessed by the terminal apparatus 200, including volatile and non-volatile media, movable and immovable medium.

The memory 210 may also include computer system readable medium in the form of volatile memory, such as random access memory (RAM) 240 and/or cache memory 250. The terminal apparatus 200 may further include other movable/immovable, volatile/non-volatile computer system storage medium. As an example, storage system 260 can be used to read and write immovable, non-volatile magnetic medium (not shown in FIG. 7, commonly referred to as “hard driver”). Although not shown in FIG. 7, a disk driver can be provided for reading and writing to movable non-volatile disks (such as “soft disks”), as well as an optical drive for reading and writing to movable non-volatile discs (such as CD-ROM, DVD-ROM, or other optical medium). In these cases, each driver can be connected to the bus 230 through one or more data medium interfaces. The memory 210 may include at least one program product, which has a set (e.g. at least one) program module configured to perform the functions of the embodiments of the present application.

A program/utility 280 with a set (at least one) program module 270, which can be stored in, for example, the memory 210. Such program modules 270 may include, but are not limited to, an operating system, one or more application programs, other program modules, and program data, each of which may include an implementation of a network environment. The program module 270 typically performs the functions and/or methods described in the embodiments described in the present application.

The terminal apparatus 200 can also communicate with one or more external apparatuses 290 (such as a keyboard, a pointing apparatus, a display 291, etc.), and can also communicate with one or more devices that enable users to interact with the terminal apparatus 200, and/or with any apparatus that enables the terminal apparatus 200 to communicate with one or more other computing apparatuses (such as a network card, modem, etc.). This communication can be carried out through input/output (I/O) interface 292. Moreover, the terminal apparatus 200 can also communicate with one or more networks (such as a local area network (LAN), a wide area network (WAN), and/or a public network, such as the Internet) through a network adapter 293. As shown in the figure, the network adapter 293 communicates with other modules of terminal apparatus 200 through the bus 230. It should be understood that although not shown in the figure, other hardware and/or software modules can be used in conjunction with the terminal apparatus 200, including but not limited to: microcode, apparatus drivers, redundant processing units, external disk drive arrays, RAID systems, tape drives, and data backup storage systems, etc.

The processor 220 executes various functional applications and data processing by running programs stored in memory 210.

It should be noted that the implementation process and technical principles of the terminal apparatus in the embodiment can be found in the previous explanation of the method of controlling the pneumatic muscle device through the electromyographic signal in the embodiment of the present application, which will not be repeated herein.

The embodiment of the present application also provides a computer-readable storage medium, which stores a computer program which, when executed by a processor, causes the processor to perform the steps in the above method embodiments.

The embodiment of the present application provides a computer program product which, when running on a terminal apparatus, enables the terminal apparatus to execute the steps in the above method embodiments.

Suppose the integrated unit is achieved in the form of functional software units and is sold or used as an independent product. In that case, it can be stored in a computer readable storage medium. Based on this understanding, a whole or part of the flow process of implementing the method in the aforesaid embodiments of the present application can also be accomplished by using a computer program to instruct relevant hardware. When the computer program is executed by the processor, the steps in the various method embodiments described above can be implemented. Wherein, the computer program comprises computer program codes, which can be in the form of source code, object code, executable documents or some intermediate form, etc. The computer readable medium can include: any entity or device that can carry the computer program codes, recording medium, USB flash disk, mobile hard disk, hard disk, optical disk, computer storage device, ROM (Read-Only Memory), RAM (Random Access Memory), electrical carrier signal, telecommunication signal and software distribution medium, etc. It needs to be explained that the contents contained in the computer readable medium can be added or reduced appropriately according to the requirement of legislation and patent practice in a judicial district. For example, in some judicial districts, according to legislation and patent practice, the computer readable medium doesn't include electrical carrier signals and telecommunication signals.

In the embodiments of the present application, the descriptions of the embodiments in the present application are emphasized respectively. Regarding the part in some embodiments that is not described in detail, reference can be made to related descriptions in other embodiments.

Those skilled in the art may be aware that the elements and algorithm steps of each of the examples described in connection with the embodiments disclosed herein can be implemented in electronic hardware, or combination with computer software and electronic hardware. Whether these functions are implemented by hardware or software depends on the specific application and design constraints of the technical solution. Skilled people could use different methods to implement the described functions for each particular application; however, such implementations should not be considered beyond the scope of the present application.

It should be understood that, in the embodiments of the present application, the disclosed device/terminal device and method could be implemented in other ways. For example, the device described above is merely illustrative; for example, the division of the units is only a logical function division, and other divisions could be used in the actual implementation. For example, multiple units or components could be combined or integrated into another system, or some features can be ignored or not performed. In another aspect, the coupling or direct coupling or communicating connection shown or discussed could be an indirect, or a communicating connection through some interfaces, devices or units, which could be electrical, mechanical, or otherwise.

The units described as separate components could or could not be physically separate, the components shown as units could or could not be physical units, which can be located in one place, or can be distributed to multiple network elements. Parts or all of the elements could be selected according to the actual needs to achieve the object of the present embodiment.

As stated above, the aforesaid embodiments are only intended to explain but not to limit the technical solutions of the present application. Although the present application has been explained in detail with reference to the above-described embodiments, it should be understood for the ordinary skilled one in the art that the technical solutions described in each of the above-described embodiments can still be amended, or some technical features in the technical solutions can be replaced equivalently; these amendments or equivalent replacements, which won't make the essence of corresponding technical solution to be deviated from the spirit and the scope of the technical solution in various embodiments of the present application, should all be included in the protection scope of the present application.

1. A method of controlling a pneumatic muscle device through an electromyographic signal, the pneumatic muscle device comprising simulated muscles corresponding to target muscles of a wearer in a one-to-one correspondence manner, comprising:
obtaining electromyographic signals currently generated by each of the target muscles of the wearer of the pneumatic muscle device;
determining a behavior classification of the wearer of the pneumatic muscle device according to all of the electromyographic signals and a preset neural network model, wherein the preset neural network model is trained and obtained according to historical electromyographic signals generated by each of the target muscles;
determining a driving amount corresponding to each of the target muscles according to the behavior classification of the wearer of the pneumatic muscle device; and
driving the simulated muscles corresponding to the target muscles according to the driving amount corresponding to each of the target muscles.

2. The method according to claim 1, wherein the step of determining the behavior classification of the wearer of the pneumatic muscle device according to all of the electromyographic signals and the preset neural network model comprises:
determining a corresponding muscle strength signal according to the electromyographic signals and a preset muscle mechanics model; and
inputting the corresponding muscle strength signal into the neural network model to determine the behavior classification corresponding to each of the target muscles.

3. The method according to claim 2, wherein the preset muscle mechanics model comprises an activation function layer, a first computational layer, a second computational layer, and an output layer; and the step of determining the corresponding muscle strength signal according to the electromyographic signals and the preset muscle mechanics model comprises:
inputting the electromyographic signals into the activation function layer, wherein the activation function layer outputs corresponding muscle activation level information;
inputting length data of each of the target muscles into the first computational layer, wherein the first computational layer outputs a corresponding first force predicted value;
inputting contraction speed data of each of the target muscles into the second computational layer, wherein the second computational layer outputs a corresponding second force predicted value; and
inputting the muscle activation level information, the first force predicted value, and the second force predicted value into the output layer, wherein the output layer outputs the corresponding muscle strength signal.

4. The method according to claim 3, wherein the step of driving the simulated muscles corresponding to each of the target muscles according to the driving amount corresponding to each of target muscles comprises:
sending the driving amount to an embedded system to generate a drive voltage corresponding to the simulated muscle of each of the target muscles; and
outputting the drive voltage to a voltage terminal of the simulated muscle corresponding to the drive voltage.

5. The method according to claim 4, wherein before obtaining the electromyographic signals currently generated by each of the target muscles of the wearer of the pneumatic muscle device, further comprises:
obtaining electromyographic signals to be processed generated by each of the target muscles of the wearer; and
performing signal processing on the electromyographic signals to be processed to obtain the electromyographic signals.

6. The method according to claim 3, wherein after inputting the electromyographic signals into the activation function layer, and the activation function layer outputs corresponding muscle activation level information, further comprising:
generating a muscle activation level distribution map according to the muscle activation level information of each of the target muscles; and
sending the muscle activation level distribution map to a display terminal designated by the wearer, to display the muscle activation level distribution map on the display terminal.

7. The method according to claim 1, further comprising:
collecting curvature data and the electromyographic signals corresponding to each of the target muscles of the wearer; and
calibrating a preset muscle mechanics model according to the curvature data and the electromyographic signals.

8. The method according to claim 2, further comprising:
collecting curvature data and the electromyographic signals corresponding to each of the target muscles of the wearer; and
calibrating the preset muscle mechanics model according to the curvature data and the electromyographic signals.

9. The method according to claim 3, further comprising:
collecting curvature data and the electromyographic signals corresponding to each of the target muscles of the wearer; and
calibrating the preset muscle mechanics model according to the curvature data and the electromyographic signals.

10. The method according to claim 4, further comprising:
collecting curvature data and the electromyographic signals corresponding to each of the target muscles of the wearer; and
calibrating the preset muscle mechanics model according to the curvature data and the electromyographic signals.

11. The method according to claim 5, further comprising:
collecting curvature data and the electromyographic signals corresponding to each of the target muscles of the wearer; and
calibrating the preset muscle mechanics model according to the curvature data and the electromyographic signals.

12. The method according to claim 6, further comprising:
collecting curvature data and the electromyographic signals corresponding to each of the target muscles of the wearer; and
calibrating the preset muscle mechanics model according to the curvature data and the electromyographic signals.

13. A terminal apparatus, comprising a memory, a processor, and a computer program stored in the memory and capable of running on the processor which, when executed by the processor, causes the processor to perform steps as follows:
obtaining electromyographic signals currently generated by each of target muscles of a wearer of a pneumatic muscle device;
determining a behavior classification of the wearer of the pneumatic muscle device according to all of the electromyographic signals and a preset neural network model, wherein the preset neural network model is trained and obtained according to historical electromyographic signals generated by each of the target muscles;
determining a driving amount corresponding to each of the target muscles according to the behavior classification of the wearer of the pneumatic muscle device; and
driving simulated muscles corresponding to the target muscles according to the driving amount corresponding to each of the target muscles.

14. The terminal apparatus to claim 13, wherein the step of determining the behavior classification of the wearer of the pneumatic muscle device according to all of the electromyographic signals and the preset neural network model comprises:
determining a corresponding muscle strength signal according to the electromyographic signals and a preset muscle mechanics model; and
inputting the corresponding muscle strength signal into the neural network model to determine the behavior classification corresponding to each of the target muscles.

15. The terminal apparatus to claim 14, wherein the muscle mechanics model comprises an activation function layer, a first computational layer, a second computational layer, and an output layer; and the step of determining the corresponding muscle strength signal according to the electromyographic signals and the preset muscle mechanics model comprises:
inputting the electromyographic signals into the activation function layer, wherein the activation function layer outputs corresponding muscle activation level information;
inputting length data of each of the target muscles into the first computational layer, wherein the first computational layer outputs a corresponding first force predicted value;
inputting contraction speed data of each of the target muscles into the second computational layer, wherein the second computational layer outputs a corresponding second force predicted value; and
inputting the muscle activation level information, the first force predicted value, and the second force predicted value into the output layer, wherein the output layer outputs the corresponding muscle strength signal.

16. The terminal apparatus to claim 15, wherein the step of driving the simulated muscles corresponding to each of the target muscles according to the driving amount corresponding to each of target muscles comprises:
sending the driving amount to an embedded system to generate a drive voltage corresponding to the simulated muscles of each of the target muscles; and
outputting the drive voltage to a voltage terminal of the simulated muscle corresponding to the drive voltage.

17. The terminal apparatus to claim 16, wherein before obtaining the electromyographic signals currently generated by each of the target muscles of the wearer of the pneumatic muscle device, further comprises:
obtaining electromyographic signals to be processed generated by each of the target muscles of the wearer; and
performing signal processing on the electromyographic signals to be processed to obtain the electromyographic signals.

18. The terminal apparatus according to claim 15, wherein after inputting the electromyographic signals into the activation function layer, and the activation function layer outputs corresponding muscle activation level information, further comprising:
generating a muscle activation level distribution map according to the muscle activation level information of each of the target muscles; and
sending the muscle activation level distribution map to a display terminal designated by the wearer, to display the muscle activation level distribution map on the display terminal.

19. The terminal apparatus according to claim 13, further comprising:
collecting curvature data and the electromyographic signals corresponding to each of the target muscles of the wearer; and
calibrating the preset muscle mechanics model according to the curvature data and the electromyographic signals.

20. A computer-readable storage medium storing a computer program which, when executed by a processor, causes the processor to perform steps as follows:
obtaining electromyographic signals currently generated by each of target muscles of a wearer of a pneumatic muscle device;
determining a behavior classification of the wearer of the pneumatic muscle device according to all of the electromyographic signals and a preset neural network model, wherein the preset neural network model is trained and obtained according to historical electromyographic signals generated by each of the target muscles;
determining a driving amount corresponding to each of the target muscles according to the behavior classification of the wearer of the pneumatic muscle device; and
driving simulated muscles corresponding to the target muscles according to the driving amount corresponding to each of the target muscles.
